(19) United States
(12) Patent Application Publication
(10) Pub. No.: US 2016/0011617 A1
(43) Pub. Date: Jan. 14, 2016

(54) POWER MANAGEMENT OF SERVER INSTALLATIONS

(71) Applicant: MICROSOFT TECHNOLOGY LICENSING, LLC, Redmond, WA (US)

(72) Inventors: Jie LIU, Medina, WA (US); Brian JANOUS, Issaquah, WA (US); Gregory Joseph McKnight, Bellevue, WA (US); Sean JAMES, Olympia, WA (US); Ricardo BIANCHINI, Bellevue, WA (US)

(73) Assignee: MICROSOFT TECHNOLOGY LICENSING, LLC, Redmond, WA (US)

(21) Appl. No.: 14/674,821

(22) Filed: Mar. 31, 2015

Related U.S. Application Data
(60) Provisional application No. 62/023,772, filed on Jul. 11, 2014.

(51) Int. Cl. G05F 1/66; G05B 15/02; G06F 9/48

(52) U.S. Cl. CPC G05F 1/66; G06F 9/4893; G05B 15/02

(57) ABSTRACT

This document relates to power management of server installations. One example determines a current generator state of a generator in a server installation and an energy storage state of an energy storage device in the server installation. The example also selectively discharges the energy storage device and adaptively adjust workload performed by a server in the server installation based on the current generator state and the energy storage state.

### PRIORITY

This application is a utility application that claims priority from provisional application 62/023,772 filed Jul. 11, 2014, which is incorporated by reference in its entirety.

### BACKGROUND

Electrical utilities, power plant operators, and/or grid operators are faced with certain difficulties when providing electrical power to a broad range of consumers. For example, electrical utilities may rely on energy sources that vary in availability, e.g., available solar power generally varies throughout the day and also with the weather. Likewise, wind power may vary daily and/or seasonally with the weather.

In addition, demand for electrical power does not typically correlate directly to the availability of power from these energy sources. For example, electrical power consumed by households tends to increase in the evening hours due to watching television, cooking, showering, etc., while the availability of solar energy at these times is limited. In addition, large energy consumers such as server installations (e.g., data centers, server farms, etc.) may provide increased demand for electrical power at times when certain energy sources are limited or unavailable for the grid operator.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to controlling energy hardware and servers. One example includes a method or technique that can be performed by a computing device. The method or technique can include determining a current generator state of a generator in a server installation, determining a level of discharge of an energy storage device in the server installation, and, based on the current generator state and the level of discharge, selectively discharging the energy storage device and adaptively adjusting workload performed by a server in the server installation.

Another example includes a system that includes a hardware processing unit and a hardware storage device storing instructions. When the instructions are executed by the hardware processing unit, the instructions can cause the hardware processing unit to determine a targeted quantity of electrical power for a server installation to supply to a grid or to draw from the grid, perform an analysis of a generator state and an energy storage state at the server installation, and, based on the analysis, cause the server installation to supply the targeted quantity of electrical power to the grid or to draw the targeted quantity of electrical power from the grid by adjusting a server workload at the server installation and adjusting at least one of the generator state or the energy storage state.

Another example includes a method or technique that can be performed by a computing device. The example includes determining a generator state within a server installation, determining an energy storage state within the server installation, and determining a grid state on a grid that provides energy to the server installation. The method can also include analyzing the generator state, the energy storage state, and the grid state to determine an energy hardware action or a server action to apply at the server installation and causing the server installation to apply the energy hardware action or the server action.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1 and 2 illustrate example scenarios consistent with some implementations of the present concepts.

FIG. 3 illustrates an example environment consistent with some implementations of the present concepts.

FIGS. 4, 5, and 6 illustrate example methods or techniques consistent with some implementations of the present concepts.

FIGS. 7 and 8 illustrate example algorithms consistent with some implementations of the present concepts.

FIG. 9 illustrates an example server installation consistent with some implementations of the present concepts.

### DETAILED DESCRIPTION

### Overview

One way for a grid operator such as an electrical utility to handle transient demand spikes or sustained periods of increased demand is to use a “spinning reserve” of online power generators that are ready at any given time to respond to increased demand on the grid. However, these generators have substantial up-front costs and additional associated costs with keeping the generators running, even when they are not being used to supplement the grid with additional electrical power. Another way for a grid operator to handle temporary power deficiencies is to employ a peaking power plant that runs only during periods of high demand for power. However, these peaking power plants are also very expensive and tend to be used very infrequently.

Some server installations (e.g., data centers, server farms, etc.) use sufficient quantities of power that they constitute a relatively high portion of the electrical power provided on a given grid. In addition, server installations may also have local power generation capacity. In some implementations, a server installation may actively supply power to the grid, e.g., by connecting directly to a power generation facility or otherwise connecting to the supply side of the grid (e.g., to a power generation facility or transmission substation). In other implementations, a server installation connected to the consumption side of a grid (e.g., downstream of a power substation) may manipulate its own power consumption in a manner that helps the grid operator address some of the aforementioned issues.

Server installations can have several characteristics that enable them to benefit a grid operator. First, as mentioned above, server installations may have local power generation capacity that can be used to either provide supplemental power to the grid or to power servers in the server installation, rather than drawing that power from the grid. In addition, server installations can have local energy storage devices such as batteries (e.g., located in uninterruptable power supplies). Server installations can selectively charge their local energy storage devices under some circumstances so that the grid sees an additional load, and can selectively discharge their local energy storage devices under other circumstances so that the server installation either reduces its load on the grid or transfers net power to the grid. In addition, server installations can adjust local workloads so that the servers themselves draw more or less power at different times, e.g., by scheduling workloads at particular times and/or moving the workloads to different server installations. For example, a server installation may place one or more servers in a low power state under some circumstances and transition the servers to higher power utilization states under different circumstances.

In some disclosed implementations, server installations adaptively adjust some or all of the aforementioned parameters, e.g., (1) on-site generation of power, (2) on-site energy storage of power, and (3) power utilization by the servers. Because of the flexibility to adjust these three parameters, server installations may be well-equipped to help grid operators deal with various circumstances on the grid. For example, server installations may be able to help grid operators deal with short or long term power deficits, low or high voltage conditions, power factor correction, etc. Thus, the relationship between a grid operator and a server installation can be made synergistic by appropriate management of a given server installation.

For the purposes of this document, the term “energy hardware” encompasses devices such as generators, batteries, power supplies, electrical wiring, etc., that exists in a given server installation for the purposes of powering one or more servers. Parameters (1) and (2) mentioned above may be adjusted by taking various “energy hardware actions” such as turning on or off generators, adjusting output of running generators, charging or discharging batteries, etc. Parameter (3) mentioned above can be adjusted by taking various “server actions” such as placing a given server into a low power state, moving workloads from one server to another, throttling or stopping various services on a given server, etc.

Some server installations may have significant flexibility in terms of both energy hardware actions and server actions that can be applied to change the amount of energy drawn or provided to the grid. In some cases, server installations may be relatively over-provisioned in terms of on-site generation capacity and/or energy storage capacity. For example, some server installations may have the capacity to generate more power locally than the servers can draw even at full server utilization. Likewise, some server installations may have enough energy storage capacity to power the servers at full utilization for substantially longer than it would take to obtain other sources of power, e.g., by using the on-site generation. For example, some on-site power generators can be fully operational and providing maximal power output within about 10 seconds, whereas a server installation may have adequate energy storage capacity to power the servers for 90 seconds. As a consequence, a given server installation may have a reservoir of power to draw from to supplement the grid even without throttling the local servers. When this extra capacity is coupled with throttling energy consumption by the servers, even more capacity can be shared with the grid. Viewed from one perspective, coordinating energy hardware actions with server actions to a defined end goal can provide benefits to both the server installation and the grid.

### Example Supply-Side Server Installation Scenario

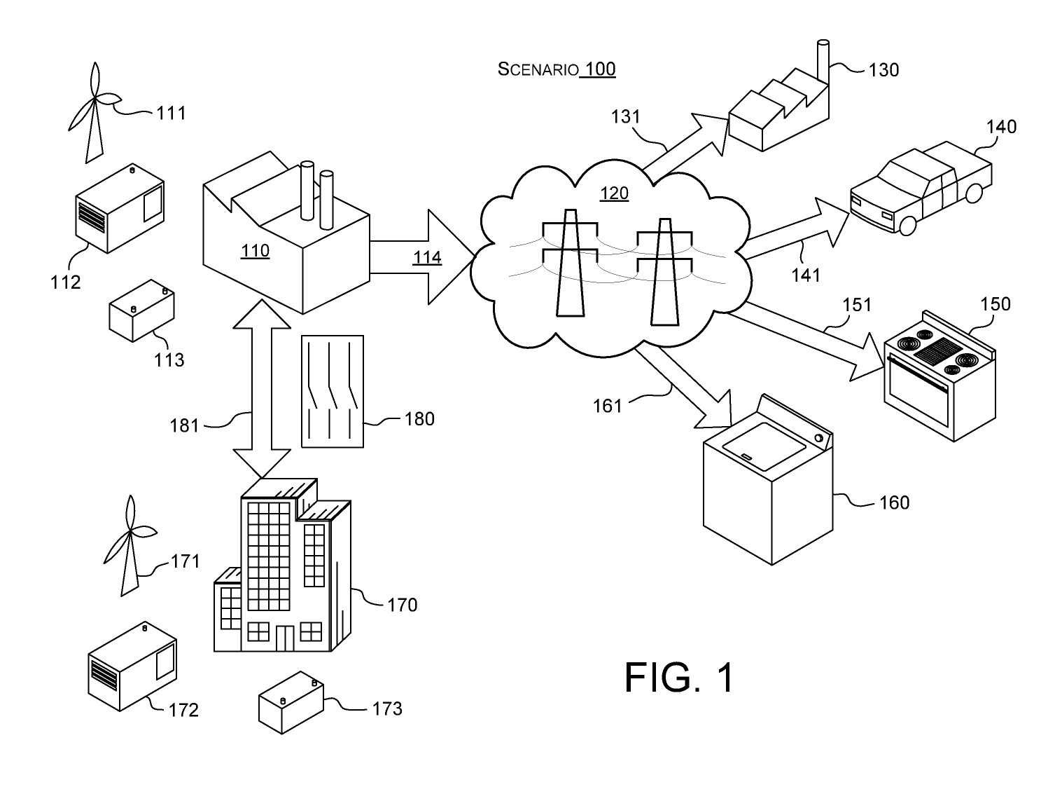

FIG. 1 illustrates an example scenario 100 with a power generation facility 110 providing electrical power to an electrical grid 120 having electrical consumers 130-160. In the example of FIG. 1, the electrical consumers are shown as a factory 130, electric car 140, electric range 150, and washing machine 160, but those skilled in the art will recognize that any number of different electrically-powered devices may be connected to grid 120. Generally speaking, the power generation facility provides power to the grid and the electrical consumers consume the power, as illustrated by the directionality of arrows 114, 131, 141, 151, and 161, respectively. Note that, in some cases, different entities may manage the power generation facility and the grid (e.g., a power generation facility operator and a grid operator) and in other cases the same entity will manage both the power generation facility and the grid.

FIG. 1 also shows a server installation 170 connected to the power generation facility 110 via a switch 180. Switch 180 may allow power to be sent from the power generation facility to the server installation or from the server installation to the power generation facility as shown by bi-directional arrow 181. In some cases, the switch can be an automatic or manual transfer switch. Note that in this example, the power generation facility is shown with corresponding energy sources 111-113, which include renewable energy generators 111 (e.g., wind, solar, hydroelectric), fossil fuel generators 112, and energy storage devices 113. Note that the power generation facility may have one or more main generators as well as other generators for reserve capacity, as discussed more below.

For the purposes of this document, the term “energy source” encompasses generators, energy storage devices, or other mechanisms that can be used to obtain energy. The term “generator” can also refer to any power generation mechanism and also includes generators powered by renewable technologies, nuclear technologies, fuel cells, etc. The term “energy storage device” encompasses technologies such as electrochemical batteries, capacitors, mechanical energy storage (e.g., water pumped to a given elevation, compressed air, etc.), thermal storage, or other technologies. In some specific implementations, the energy storage devices are electrochemical batteries provided that can be charged by sources including fossil fuel generators 112, which can be powered by diesel, natural gas, etc. In some cases, batteries or other energy storage devices may be provided in uninterruptible power supplies used to power various servers. Note also that the terms charging and discharging as used herein generally means adding stored energy to or removing stored energy from an energy storage device, and is not limited to merely charging of electrochemical batteries. For example, charging may encompass moving water from a lower elevation to a higher elevation, adding thermal energy to a thermal energy source, etc.

Like the power generation facility, the server installation may also have energy sources 171-173 shown as renewable energy generators 171, fossil fuel generators 172, and energy storage devices 173. Note that the power generation facility and server installation do not necessarily have the same energy sources, e.g., in some cases, the power generation facility may lack fossil fuel generators and the server installation may lack renewable energy generators or vice versa, as well as various other combinations of power generating/storage equipment. Furthermore, either the power generation facility and/or server installation may have other energy sources not shown (e.g., nuclear, fuel cells, etc.).

Internally, the server installation 170 may have multiple server racks powered by corresponding power supplies. The power supplies may rectify current provided to the server power supplies from alternating current to direct current. In addition, the server installation may have appropriate internal transformers to reduce voltage produced by the server installation or received from the power generation facility to a level of voltage that is appropriate for the server power supplies. In further implementations discussed more below, the server power supplies may have adjustable impedance so they can be configured to intentionally draw more/less power from the power generation facility.

In some implementations, the switch 180 can be an open transition switch and in other cases can be a closed transition switch. In the open transition case, the switch is opened before power generation at the server installation is connected to the grid. This can protect the grid from potential problems caused by being connected to the generators. Generally, a grid operator endeavors to maintain the electrical state of the grid within a specified set of parameters, e.g., within a given voltage range, frequency range, and/or power factor range. By opening the switch before turning on the generators, the server installation can avoid inadvertently causing the electrical state of the grid to fluctuate outside of these specified parameters.

Because the open transition scenario does not connect running generators to the grid, this scenario can prevent the server installation from providing net power to the grid. Nevertheless, the server installation can still adjust its load on the grid using the switch 180. For example, switch 180 can include multiple individual switches and each individual switch can be selectively opened/closed so that the grid sees a specified electrical load from the server installation. Generators connected to the closed switches may generally be turned off or otherwise configured not to provide power to the grid, whereas generators connected to the open switches can be used to provide power internally to the server installation or, if not needed, can be turned off or idled. Likewise, servers can be configured into various power consumption states and/or energy storage devices can be charged or discharged to manipulate the electrical load placed on the grid by the server installation.

In the closed transition case, the generators can be connected to the grid when generating power. As a consequence, either net power can flow from the grid to the server installation (as in the open transition case) or net power can flow from the server installation to the grid. However, particularly in the closed transition case, the server installation can inadvertently cause the grid to fluctuate outside of the specified voltage, frequency, and/or power factor parameters mentioned above. Thus, in some cases, the generators can be turned on and the sine waves of power synchronized with the grid before the switch is closed, e.g., using paralleling switchgear to align the phases of the generated power with the grid power. If needed, the local energy storage of the server installation can be utilized to provide power to the local servers during the time the generators are being synchronized with the grid. Note that closed transition implementations may also use multiple switches, where each switch may have a given rated capacity and the number of switches turned on or off can be a function of the amount of net power being drawn from the grid or the amount of net power being provided to the grid.

There are additional subtleties to the closed vs. open transition scenarios mentioned above. In the closed transition scenario, the amount of net power that can be provided to the grid at any given time is a function of the peak power output of the generators (including possibly running them in short-term overload conditions for a fixed number of hours per year) as well as power from energy storage (e.g., discharging batteries). For example, if the generators are capable of generating 100 megawatts and the energy storage devices are capable of providing 120 megawatts (e.g., for a total of 90 seconds at peak discharge rate), then a total of 220 megawatts can be sent to the grid for 90 seconds and thereafter 100 megawatts can still be sent to the grid. In addition, generation and/or energy storage capacity can be split between the grid and the servers, e.g., 70 megawatts to the servers and 150 megawatts to the grid for up to 90 seconds and then 30 megawatts to the grid thereafter, etc.

In the open transition scenario, however, the amount of capacity that can be given back to the grid is a function of the amount of power being drawn by the servers. For example, if the servers are only drawing 10 megawatts but the server installation has the aforementioned 100 megawatt generation capacity and 120 megawatts of power from energy storage, the server installation can only “give back” 10 megawatts of power to the grid because the servers are only drawing 10 megawatts. This could be accomplished by throttling the server workload down to 0 megawatts of power consumption. Thus, the ability of the server installation to help mitigate problems in the grid can be viewed as partly a function of server load.

Note that in either the closed or open transition case, energy storage devices can be selectively charged to create a targeted load on the grid. In other words, if the batteries can draw 30 megawatts of power when charging, then in either case an additional 30 megawatts can be drawn from the grid so long as the energy storage devices are not fully charged. In some cases, the amount of power drawn by the batteries when charging may vary with the charge state of the energy storage devices, e.g., they may draw 30 megawatts when almost fully discharged (e.g., 10% charged) and may draw only 10 megawatts when almost fully charged (e.g., 90% charged).

### Example Consumption Side Server Installation Scenario

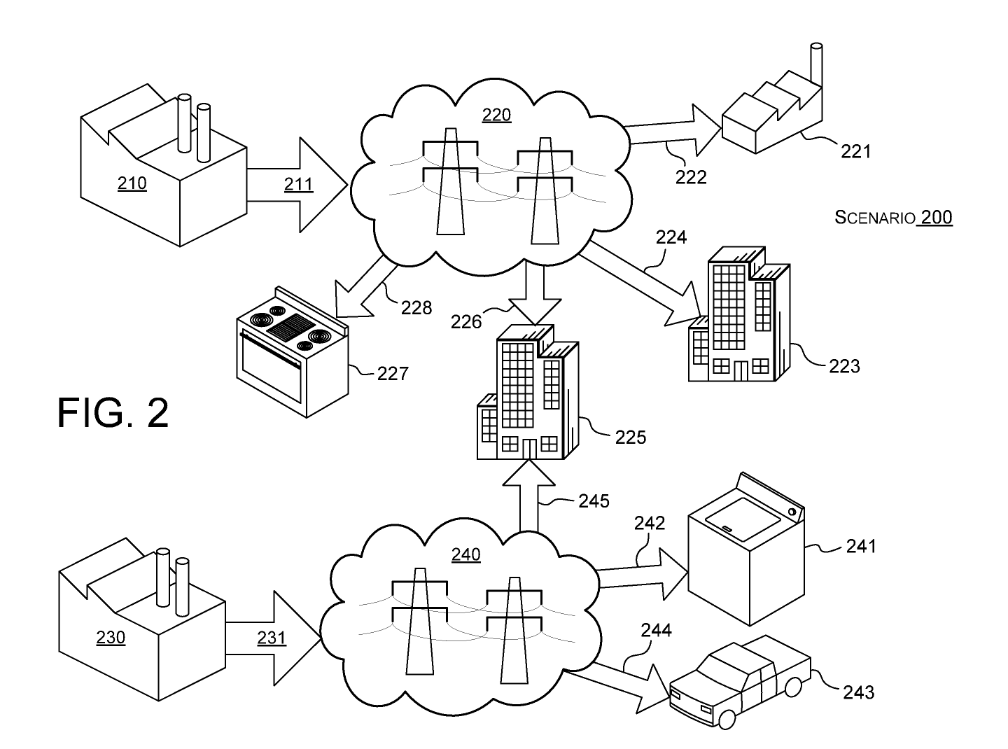

FIG. 2 illustrates an example scenario 200 with a power generation facility 210 providing electrical power to an electrical grid 220 as shown at arrow 211. In this example, electrical grid 220 provides power to consumers 221, 223, 225, and 227 as shown by arrows 222, 224, 226, and 228. In this example, the consumers include factory 221 and electric range 227, and also server installations 223 and 225. In some cases, the server installations 223 and 225 may lack a closed-transition switch or other mechanism for sending power back to the power generation facility 210. Nevertheless, as discussed more below, power consumption by server installations 223 and 225 may be manipulated to provide benefits to an operator of power generation facility 210 and/or electrical grid 220.

Scenario 200 also includes another power generation facility 230 providing electrical power to another electrical grid 240 as shown at arrow 231. In this example, electrical grid 240 provides power to consumers 241 and 243 (illustrated as a washing machine and electric car) as shown by arrows 242 and 244. Note that in this example, server installation 225 is also connected to electrical grid 240 as shown at arrow 245. Thus, server installation 225 can selectively draw power from either electrical grid 220 or electrical grid 240, as discussed more below.

Note that server installations 223 and 225 may have similar energy sources such as those discussed above with respect to server installation 170. In certain examples discussed below, server installation 223 can selectively use power from electrical grid 220 and local batteries and/or generators at server installation 223. Likewise, server installation 225 can selectively use power from electrical grid 220, electrical grid 240, and local batteries and/or generators at server installation 225. In some cases, server installation 223 and/or 225 may operate for periods of time entirely based on local energy sources without receiving power from electrical grids 220 and 240.

### Example Network Scenario

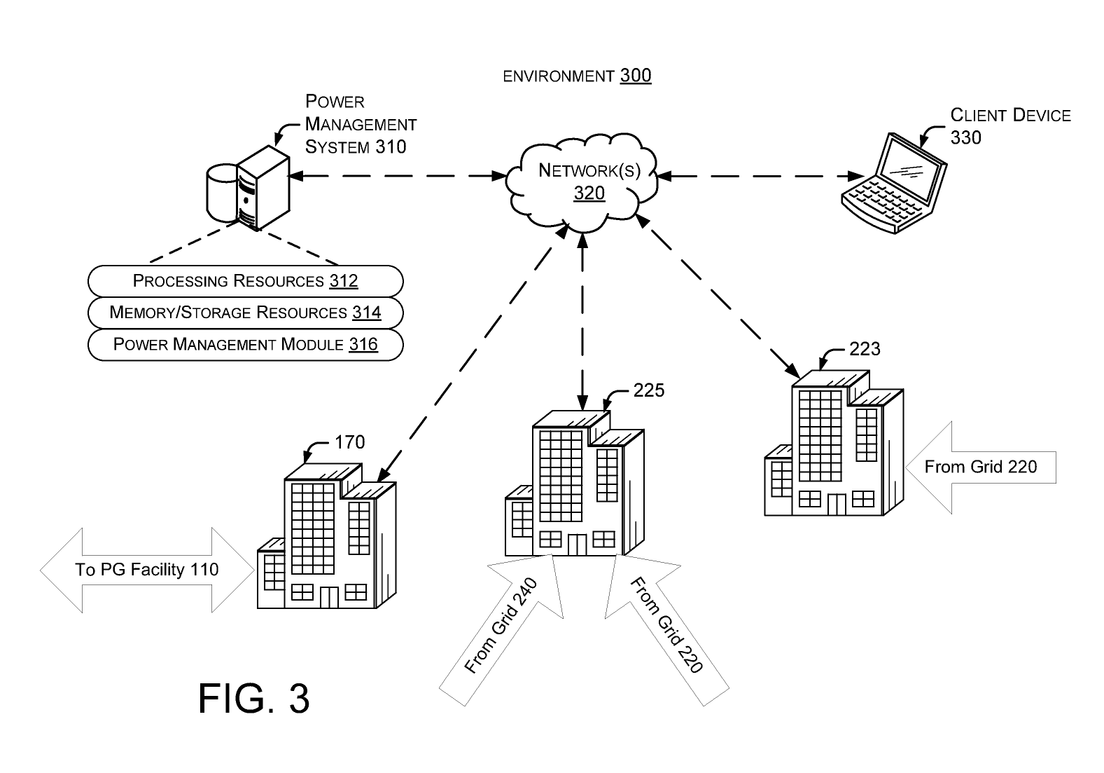

One specific environment in which the disclosed techniques can be performed is shown in FIG. 3, which shows an example environment 300 including a power management system 310 connected via a network 320 to a client device 330 and server installations 170, 223, and 225. Generally speaking, the client device may request various services from any of the server installations, which in turn use electrical power to perform computational work on behalf of the client device. The power management system may transmit various instructions to the individual server installations to cause the server installations to perform power hardware actions and/or server actions as discussed elsewhere herein.

Power management system 310 may provide power management functionality such as controlling the amount of power consumed at any given time by any of the server installations. For example, the power management system may cause any of the server installations to use locally-sourced power from local energy storage devices, generators, or other energy sources instead of obtaining power from a power generation facility or grid. In addition, the power management system may cause any of the server installations to throttle data processing for certain periods of time in order to reduce total power consumption (e.g., by placing one or more servers in a low power consumption state). In addition, referring back to FIG. 1, power management system 310 may control switch 180 to cause power to flow from power generation facility 110 to server installation 170 or from server installation 170 to power generation facility 110.

More specifically, the power management system 310 can be configured to determine a targeted quantity of electrical power for a server installation to supply to a grid or to draw from the grid. The power management system can perform an analysis of generator state and energy storage state at the server installation. Based on the analysis, the power management system can cause the server installation to supply the targeted quantity of electrical power to the grid or to draw the targeted quantity of electrical power from the grid. The power management system can do so by causing servers at the server installation to adjust workloads as well as causing the generator state and/or energy storage state to change.

For the purposes of this document, the term “generator state” refers generally to the operational state of a generator. For example, this term can encompass whether a given generator is currently running, whether a given generator is currently warmed up and able to provide electrical power, the amount of power being currently generated by a given generator, etc. This term can also encompass whether the generator is in an “overload state” where the generator is producing greater than its rated capacity of power, as well as how long the generator has been running in the overload state. Some generators are rated to run in overload states for a specified number of hours per year and the number of hours currently used can be a factor in how the power management system performs the functionality discussed herein.

For the purposes of this document, the term “energy storage state” refers generally to the operational state of an energy storage device. This term encompasses the current discharge state of an energy storage device, whether the energy storage device is currently being charged or discharged, the rate at which the energy storage device is being charged or discharged, etc. This term also can encompass historical information that may be useful for determining the usable lifetime of an energy storage device. In the case of a battery, the historical information can include the age of the battery, the number of previous discharge cycles, and/or the depth of previous discharge cycles. For some batteries, very deep discharge cycles (e.g., below 10%) can have significant negative impacts on the life of the battery, and the power management system can take this into account when performing the functionality discussed herein.

Note that power management system 310 is shown in FIG. 3 as located externally from server installations 170, 223, and 225. In further implementations, power management system 310 may be collocated with any or all of the server installations. For example, in some cases, each server installation may have an instance of the power management system located therein and the local instance of the power management system may control power usage/generation at the corresponding server installations. In other cases, each server installation may be controlled over network 320 by a single instance of the power management system 310. Also, note that power management system can include various processing resources 312, memory/storage resources 314, and a power management module 316. These components of the power management system are discussed in more detail below in the section entitled “Device Implementations.”

### Supply-Side Server Installation Method Example

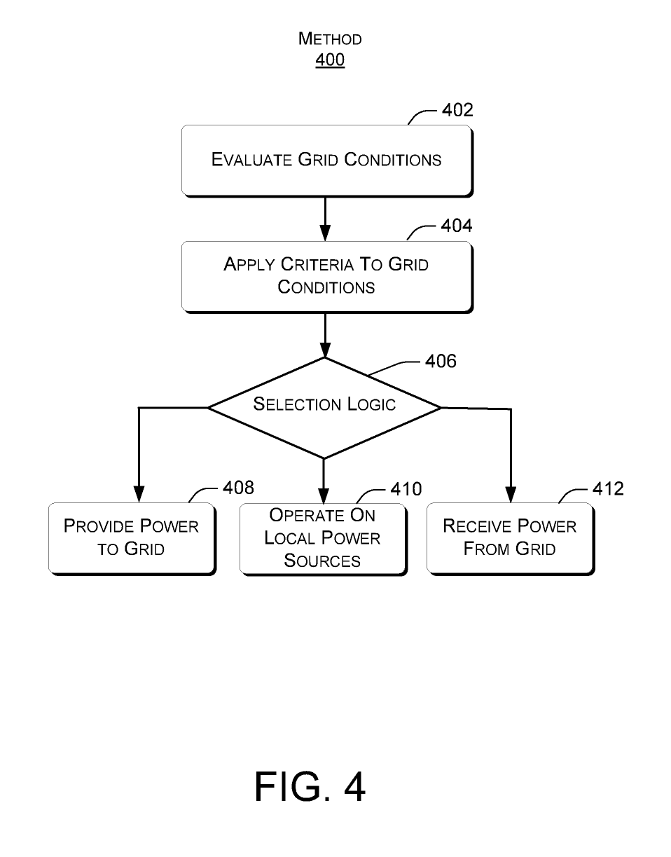

As discussed above with respect to FIG. 1, some implementations may generally regulate power usage by a server installation connected to the supply side of a grid, e.g., collocated with a power generation facility or otherwise operably connected to an electrical grid in a manner that allows the server installation to supply power to the electrical grid. FIG. 4 shows a method 400 that can be performed by power management system 310 (FIG. 3) or by other systems.

Block 402 of method 400 can include evaluating grid conditions on an electrical grid. For example, the power management system 310 can evaluate conditions on grid 120 (FIG. 1) in view of demand for electrical power as well as available supply of electrical power, e.g., using the current rate charged for power (e.g., the price) or another value that quantifies the relationship between energy supply and energy demand. More generally, grid conditions can be represented by various types of grid condition signals, as discussed more below.

Block 404 of method 400 can include applying various criteria to the grid conditions to see whether the criteria are met. For example, in some cases, supply/demand criteria may indicate whether the grid has an oversupply or undersupply of power from energy sources of a power generation facility (e.g., refs. 111, 112, 113 in FIG. 1). In some cases, the supply/demand criteria may indicate whether a power generation facility can produce adequate power for the grid without obtaining supplemental power from a connected server installation. As another example, criteria may relate to current energy cost on the grid, e.g., the current or future expected cost of electricity.

Block 406 can include applying selection logic based on whether the criteria are met. Generally, the selection logic can be applied to cause the server installation to place a targeted electrical load on the grid and/or supply a targeted amount of electrical power to the grid.

Block 408 can include sending power from the server installation to the power generation facility or directly to the electrical grid, e.g., the grid ultimately receives a targeted amount of net power produced by the server installation. For example, as discussed more below, the server installation can be controlled to send net power to the grid when supply/demand criteria indicate the grid is undersupplied given current or expected demand. As another example, the server installation can be controlled to send net power to the grid when a given threshold is met, e.g., the rate for electricity exceeds a certain value.

Block 410 can include operating the server facility on local energy sources without receiving power from the grid or sending power to the grid. For example, server installation 170 can operate solely on local energy sources 171, 172, and/or 173 in instances when electrical grid 120 is down. As another example, server installation 170 can operate solely on these energy sources when the rate for power exceeds another threshold, e.g., the rate is high enough to merit using local energy sources but is not high enough to merit reducing computation work and sending power to the grid.

Block 412 can include receiving power at the server installation directly from the power generation facility and/or from the grid. For example, server installation 170 can do so when local energy sources are insufficient to meet computational loads on the servers and/or to place a targeted electrical load on the grid. As another example, the server installation can operate on power received directly from the power generation facility and/or grid when the rate for electricity is relatively low.

Note that the aforementioned discussion uses three distinct blocks 408, 410, and 412 to provide a simple conceptual example. In many cases, the power management system 310 will actually cause the server installation to operate over a continuum of states that range from providing all power generated at the server installation to the power generation facility and/or grid to not using any local energy sources and instead using only power received directly from the power generation facility and/or grid.

### Specific Examples of Supply-Side Server Installation Power Management

### Energy Storage

Generally, a power generation facility may maintain a “spinning reserve” of power generation capacity. For example, several generators may be turned on and physically connected to the supply side of an electrical grid. In this configuration, the power output of the generators can quickly be increased in response to increased demand on the grid.

In some implementations, energy storage devices 173 (FIG. 1) at a server installation 170 can be used to supplement or replace the spinning reserve capacity of power generation facility 110. During periods when the power generation facility is producing an excess of power (e.g., supply exceeds demand on electrical grid 120), the power management system 310 can divert this power to the energy storage so that the energy storage can be charged. For example, batteries may be charged by rectifying AC power at the server installation. At other times when demand exceeds supply on electrical grid 120, the energy storage devices can be used to supplement power to the grid, e.g., by inverting the DC power from DC batteries. In either case, power can flow between the server installation and power generation facility via switch 180.

Also note that there may be times when the power generation facility 110 has a short-term oversupply of power and needs to divert this power away from the electrical grid 120. For example, it may take a certain amount of time for the power generation facility to turn off fossil fuel generators 112 in response to decreased demand. During this time, the power generation facility generators may be producing more power than is usable by electrical grid 120. Under these circumstances, power management system 310 can divert power produced by the generators to the server installation facility via switch 180, e.g., to charge energy storage devices 173.

Note that, in some cases, the energy storage devices 173 provisioned at the server installation 170 can be a function of the spinning reserve requirement of the power generation facility 110. For example, suppose that the power generation facility is determined to need a specified amount of spinning reserve capacity. Instead of supplying enough fossil fuel generators 112 to act as the spinning reserve, a similar amount of energy storage capacity can be provided at the server installation. In further implementations, the amount of energy storage capacity at the server installation can be sufficient both to act as the spinning reserve for the power generation facility and additional capacity for server backup purposes (e.g., in the event of a grid failure, failure by one or more server installation generators, etc.).

### Generators

In some cases, server installations have backup generation capacity largely to deal with outages on the grid. This allows the server installations to continue to provide computational services to remote clients in the event of grid outages. In many cases, however, the server installation may normally draw power from the grid.

By collocating power generation facility 110 and server installation 170, the backup generator capacity of the power generation facility (e.g., fossil fuel generators 112) can be used to supplement or replace the backup generator capacity of the server installation (e.g., fossil fuel generators 172). In some cases, the backup generator capacity for the server installation may be omitted entirely. When the electrical grid 120 suffers an outage, the server installation can obtain power from fossil fuel generators 172 because the server installation is on-site with the power generation facility. This may render the server installation at least partly immune to grid outages, and also save costs associated with creating the server installation. The server installation may also be given priority over output from the fossil fuel generators 172 to maintain high availability of computational services.

Also, note that alternative arrangements are possible where the server installation provides backup generation capacity for the power generation facility. In other words, fossil fuel generators 112 at the power generation facility may be partially or completely omitted. In such implementations, fossil fuel generators 172 at the server installation may provide power to the power generation facility 110 to ultimately supply electrical grid 120.

### Power Directing Mechanisms

As noted above, one mechanism for directing power between the server installation 170 (FIG. 1) and the power generation facility 110 is switch 180. Switch 180 can modulate how much power goes from power generation facility 110 to server installation 170 or vice versa. This can have some benefits relative to having the server installation obtain power from the electrical grid 120, because there may be inefficiencies in transforming the power as generated by the power generation facility for transmission to the electrical grid 120 and for transforming the power on the electrical grid 120 for distribution to the various consumers. Instead of performing these transformations, the voltage produced by the power generation facility can be provided directly to the server installation which can then rectify the power for use by the server power supplies.

In some cases, the switch 180 may be a single large switch or may include multiple individual switches. In one specific implementation, switch 180 includes multiple automatic transfer switches that are configured to allow relatively small amounts of power (e.g., 100 kilowatts) to flow from the server installation to power generation facility or vice versa. Using relatively small switches in this manner may prevent overloading any corresponding generators.

For example, if power is being provided from power generation facility 110 to server installation 170, each time a switch is turned on this may cause one or more of fossil fuel generators 112 to see an increased load. For example, assume that in the space of three minutes a series of intense compute jobs are received by server installation 170. Instead of triggering a single switch to accommodate the power demands of these compute jobs, a series of transfer switches can be switched on one at a time so that the fossil fuel generators 112 will see a stepped increase in load instead of an immediate jump in load.

Also, note that some implementations may use impedance as a mechanism for directing power between the server installation 170 and power generation facility 110. For example, the server installation may have multiple different server power supplies with adjustable impedance. By lowering the impedance of the server power supplies, the power management system 310 can cause the server installation 170 to consume more power and, likewise, can increase the impedance to cause the server installation 170 to consume less power.

### Voltage Quality

In addition, the power generation facility 110 may be responsible for maintaining a consistent specified frequency, (e.g., 60 Hz) of alternating current on electrical grid 120. The power generation facility may use fossil fuel generators 112 to respond to circumstances where the frequency on the grid varies from this specified frequency. By selectively diverting appropriate amounts of power at specific times and frequencies, the power management system can help the grid maintain the specified frequency.

In some implementations, the power generation facility 110 can include a “smart inverter” that is controlled by the power management system 310 to perform power management to help the power generation facility 110 maintain voltage quality. For example, the inverters might take DC voltage from DC energy sources in the server installation 170 (e.g., batteries, fuel cells, etc.) and generate a signal that is offset in voltage and/or frequency from a specified output frequency for the power generation facility. As one specific example, assume the power generation facility is attempting to maintain 480 volts at 60 hertz on the grid, but due to short-term imbalances on the grid the voltage and/or frequency deviate from these specified values. The inverters might generate a compensatory current (e.g., 482 volts at 61 hertz) to offset these grid imbalances. In these configurations, the power management system may sense not only total power consumption/supply but also voltage quality. In addition, the power management system can perform reactive power management, e.g., by sensing a leading load on the grid and supplying a lagging load to counteract the leading load or vice-versa. More generally, a server installation with VDC generating equipment (fuel cells, etc.) can use smart inverters in accordance with the disclosed implementations to stabilize frequency, voltage, and/or power factor on an electrical grid.

### Consumption-Side Server Installation Method Example

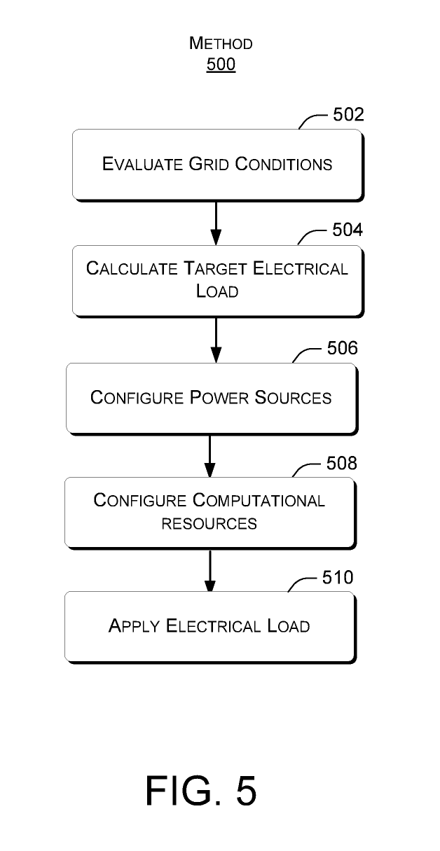

As discussed above with respect to FIG. 2, some implementations may generally regulate power usage/provisioning by a server installation connected to the consumption side of one or more grids. Generally, a server installation in such a configuration can manage the electrical load placed on the grid to the benefit of the grid, as discussed more below. FIG. 5 shows a method 500 that can be performed by power management system 310 or by other systems.

Block 502 of method 500 can include evaluating grid conditions, e.g., by receiving a grid condition signal. For example, the grid condition signal can represent voltage, frequency, energy demand, available energy supply, etc.

Block 504 of method 500 can include calculating a targeted electrical load to place on the grid. For example, this block can calculate a target load that may equalize demand and supply on the grid, present steady power utilization to the grid, and/or help the grid adjust voltage and/or frequency.

Block 506 of method 500 can include configuring energy sources at a server installation. For example, if the calculated grid load is not sufficient to power enough servers to perform existing computing jobs, generators, energy storage devices, and other energy sources at the server installation can be configured to provide any additional power needed above the calculated grid load. By transferring some of the electrical load that might normally be applied to the grid, the server installation can “give back” some of the electrical load to the grid in a manner that helps the grid adjust/stabilize voltage and/or frequency.

Block 508 of method 500 can include configuring computational resources at a server installation. For example, instead of using onsite energy sources to supply extra power needed for existing computing jobs, the computing jobs can be rescheduled within the server installation or transferred to another server installation for processing. In some cases, sufficient jobs can be transferred/delayed so that the server installation can meet the targeted electrical load without needing to use any local power.

Block 510 of method 500 can include applying the target electrical load on the grid. This generally can involve using the configured energy sources and configured computational resources so that the target electrical load is placed on the grid.

### Specific Examples of Consumption-Side Server Installation Power Management

### Steady Power Consumption

Generally, the computational load on a server installation can vary throughout the day. Typically, a server installation can present a corresponding electrical load on the associated grid. As discussed above, method 500 can include adjusting usage of local energy sources at a server installation and/or computational load at the server installation to produce a target electrical load on the grid. In some implementations, the target electrical load on the grid can be a steady electrical load (e.g., constant, nearly-constant, smoothed, etc.) instead of an electrical load that varies directly with computational load.

For example, consider FIG. 2. Here, assume server installation 223 draws a steady (e.g., flat) amount of power from electrical grid 220 irrespective of the computational load being performed within the server installation. From the perspective of power generation facility 210, this can be very useful because it may reduce or eliminate the need for the grid to rely on other technologies such as peaking power plants, resistive load banks, backup generators, etc., to handle changes in load from the server installation. Considering server installation 225, note that this server installation can draw power in a manner so that two different electrical grids 220 and 240 perceive steady power utilization from this server installation. In some cases, the server installation can be connected to two different grids with an upstream switch, and in other cases by a dual source power supply. The dual source power supply can be used to transfer electrical load linearly or in blocks.

### Supply/Demand Sensitive Power Consumption

In the previous examples, the server installations adjusted their usage of local energy sources and/or computational loads to present a constant, flat power utilization from the server installation irrespective of other conditions on the grid. In further implementations, the server installations may take account of conditions on the grid to help adjust the total power consumption on the grid (e.g., the total electrical load on the grid from both the server installation as well as other power consuming devices).

For example, during periods when demand exceeds supply on the grid, the server installation can reduce its own power consumption by reducing computation and/or using local energy sources to reduce or eliminate power drawn from the grid. Examples of such times include evening hours when many people are home and using heating/air conditioning, watching television, taking showers, cooking, etc. At these times, certain energy sources used by the power generation facility may be relatively less productive, particularly photovoltaic (solar) energy sources.

During periods when supply exceeds demand on the grid, the server installation can increase its power consumption by scheduling compute jobs for these times, charging local batteries, turning off generators for maintenance, etc. For example, late morning and afternoon times are examples of times when photovoltaic energy sources may produce more power than needed. By charging server installation batteries at these times, the server installation batteries can be used later in the day to reduce consumption by the server installation. Note that similar techniques can also be applied for transient spikes/drops in power utilization on the grid, e.g., the power management system 310 can receive various signals from the grid, sense a short-term power deficit, and react by discharging server installation energy storage devices, turning on server installation generators, delaying compute jobs, or rescheduling the compute jobs at other server installations (e.g., server installations connected to different grids). For example, in the event of a power deficit on electrical grid 220, jobs can be sent from server installation 223 to server installation 225 and server installation 225 can be configured to draw power from electrical grid 240 instead of electrical grid 220.

### Algorithms for Both Supply-Side and Consumption-Side Techniques

### Grid Condition Criteria

In some cases, the power management system 310 may control one or more server installation facilities based on the current or predicted rate charged for electrical power. Referring to FIG. 1, if the rate is very high, the energy sources 171-173 of server installation 170 can be used to generate power that is used on electrical grid 120 or perhaps sent to another (e.g., remotely-located) grid. Referring to FIG. 2, while server installations 223 and 225 may not be in a position to provide power directly over electrical grids 220 or 240, these server installations can use their own local energy sources rather than obtain power from the grid when rates are high. For example, when the rate reaches a certain point, server installations 223 and/or 225 may turn on local generators, begin discharging local energy storage, begin using local fuel cells, etc., thus reducing the amount of energy sourced from electrical grids 220 and/or 240.

Viewed from one perspective, the rate can be viewed as a grid condition signal that indicates the current load on the grid. For example, if this value increases to a certain threshold, this is a signal to the power management system 310 that demand is currently outweighing supply on a given grid. Under these circumstances, the server installations can be controlled to use their own local energy sources for some or all power. This, in turn, has the effect of causing the grid to see a stabilized power utilization from the server installation(s).

### Prediction

Some implementations may use predictive techniques to schedule usage and/or readying of local energy sources within a given server installation. For example, the power management system 310 may predict that the rate will rise to a certain threshold within an hour. The local fossil fuel generators in server installation 223 may have a 10 minute warm-up time, so the power management system may schedule the fossil fuel generators to warm up starting in 50 minutes. As another example, the power management system may predict that the price of energy in 48 hours will be relatively high (e.g., due to cloudy weather limiting solar power). Thus, the power management system may schedule the batteries to be charged within the next 48 hours, e.g., using local fossil fuel generators, energy sourced from the grid, etc.

### Server Installation Control Techniques

The following discussion includes additional details on how a server installation can be controlled to either selectively provide a targeted amount of power to a grid (as in method 400) or to place a targeted load on the grid (as in methods 400 and/or 500). Generally, these can be accomplished by controlling local power generation at a server installation, controlling local energy storage at the server installation, controlling server workloads at the server installation, and/or controlling server power states at the server installation.

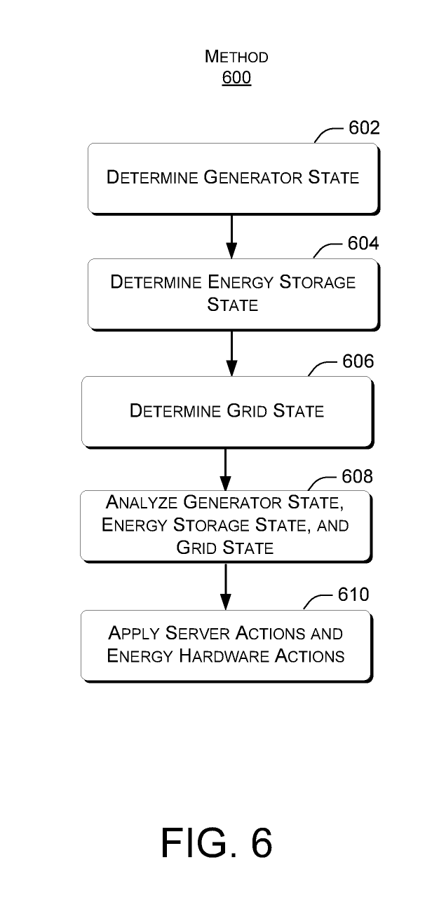

FIG. 6 shows a method 600 that can be performed by power management system 310 (FIG. 3) or other systems to coordinate control of workload and energy sources in a server installation.

Block 602 of method 600 can determine a generator state at the server installation. For example, as mentioned above, the generator state can indicate whether or not the generators are currently running at the server installation (e.g., fossil fuel generators that are warmed up and currently providing power). The generator state can also indicate a percentage of rated capacity that the generators are running at, e.g., 50 megawatts out of a rated capacity of 100 megawatts, etc.

Block 604 can include determining an energy storage state at the server installation. For example, as mentioned above, the energy storage state can indicate a level of discharge of energy storage devices in the server installation. The energy storage state can also include information such as the age of the energy storage devices, number and depth of previous discharge cycles, etc.

Block 606 can include determining a grid state, e.g., by evaluating a grid condition signal indicative of grid conditions. For example, a grid condition signal might indicate that the grid is relatively over- or under-supplied with power at a specific time. Another grid condition signal might be an explicit request from a grid operator to reduce power consumption at the server installation by a specified amount and/or provide a specified amount of net power from the server installation to the grid. Another grid condition signal might reflect voltage, power factor, or frequency fluctuations on the grid.

Block 608 can include analyzing the generator state, the energy storage state, and the grid state to determine energy hardware actions or server actions to apply. As mentioned, server actions can include turning off services at the server installation, throttling services to a lower level of utilization, moving the services to a different server installation, changing servers to different power consumptions states, etc. Power hardware actions can include charging or discharging batteries, starting or turning off generators, causing the generators to produce more or less power, synchronizing the generators with the grid (e.g., frequency), etc. Note that the analysis performed at block 608 can select actions that are intended to cause the server installation to provide or draw a targeted quantity (e.g., wattage) of power to/from the grid, as discussed elsewhere herein. Other implementations can select actions to cause the server installation to provide or draw power with a targeted quality (e.g., voltage, frequency, reactive power for power factor compensation, etc.).

Block 610 can include applying the server actions and energy hardware actions determined at block 608. The specific actions that are applied can cause the server installation to apply the targeted electrical load to the grid, provide a targeted net outflow of electrical power from the server installation to the grid, and/or provide or draw power with specified power qualities as discussed above.

Viewed from one perspective, method 600 can selectively discharge energy storage devices, selectively turn on/off generators, adaptively adjust workloads performed by one or more servers in the server installation, etc., in a manner that accomplishes the targeted load, targeted net outflow of power, and/or targeted power quality. By coordinating control of servers and energy hardware in this manner, the server installation can realize various benefits such as extending battery life, maintaining batteries in an optimal or near-optimal state of charge, appropriately throttle various services, etc. In addition, grid operators may benefit as well because the various actions taken by the server action may help prevent grid outages, provide power factor correction, etc.

### First Example Algorithm

Block 608 of method 600 can be implemented in many different ways to determine which specific actions to take to send/draw a targeted quantity and/or quality of electrical power to/from the grid. For example, some implementations may use machine learning techniques to optimize which actions are taken under which circumstances. One example such technique that can be used is a decision tree algorithm.

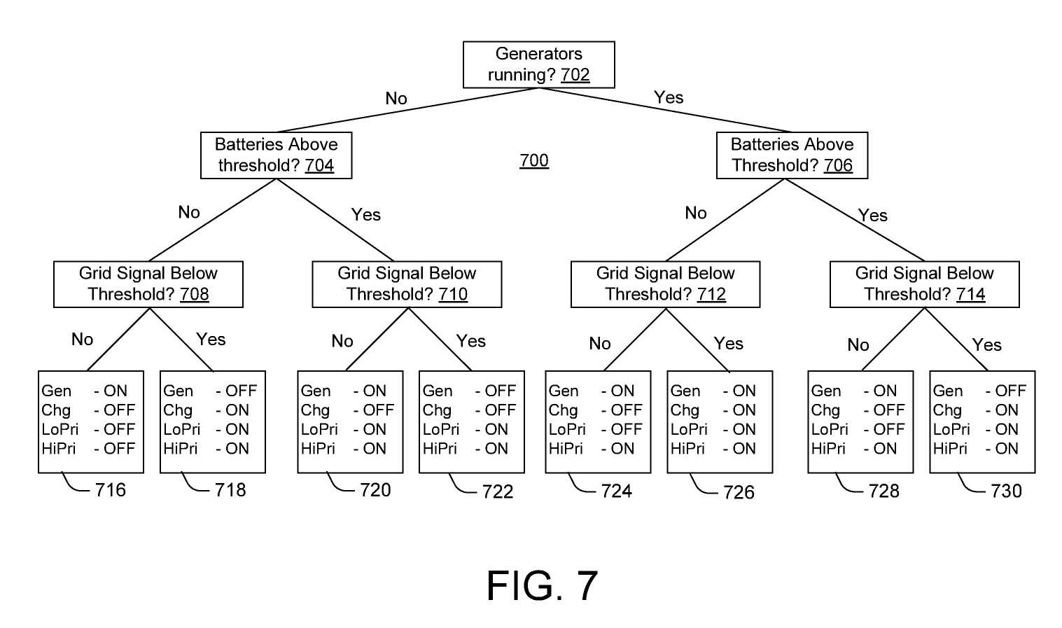

FIG. 7 illustrates an example decision tree 700 consistent with certain implementations. Decision tree 700 will be discussed in the context of fossil fuel generators that can be turned on and off and can charge batteries in a server installation, but the concepts described here can be readily extended to other types of power generating mechanisms and energy storage devices.

Decision tree 700 starts with a generator state node 702. When the generators are currently not running, the decision tree goes to the left of node 702 to battery state node 704. When the generators are currently running, the decision tree goes to the right of node 702 to battery state node 706.

The direction taken from battery state nodes 704 and 706 can depend on the current battery state. When the batteries are discharged below a certain threshold (e.g., 50%), the decision tree goes to the left of node 704/706, and when the batteries are not discharged below the threshold, the decision tree goes to the right of these nodes. The decision tree operates similarly with respect to grid state nodes 708, 710, 712, and 714. A grid condition signal can be evaluated and, when the grid condition signal (e.g., a current rate for energy provided by the grid operator) is not below a threshold, the paths to the left out of nodes 708, 710, 712, and 714 are taken to nodes 716, 720, 724, and 728. When the grid condition signal is below the threshold, the paths to the right of nodes 708, 710, 712, and 714 are taken to nodes 718, 722, 726, and 730.

Leaf nodes 716-730 represent actions taken for specific paths through decision tree 700. Consider leaf node 716, which represents actions taken when the generators are off, the battery state is below the threshold and the grid condition signal is not below the threshold. Under these circumstances, the following actions are taken—the generators are turned on, the batteries are not charged, low priority services are turned off, and high priority services are also turned off. The general idea here is that the availability of power from all three sources—the grid, the generators, and the batteries—is constrained, so each of the actions taken is designed to either minimize the amount of power consumed from the grid and/or maximize the amount of net power transferred to the grid.

As an alternative, consider leaf node 730, which represents the opposite extreme of leaf node 716, e.g., power from all three sources is readily available. Here, the generators are turned off, the batteries are charged, and both low and high priority services are executed. The general idea here is that power is readily available so the actions taken are designed to take advantage of this.

Also, note that the thresholds for different nodes of the same type can vary. For example, battery state node 704 can use a 30% threshold and battery state node 706 can use a 60% threshold. Thus, when the generators are not running, the path to grid state node 708 is taken out of battery state node 704 when the batteries are charged 30% or less and otherwise the path to grid state node 710 is taken. On the other hand, when the generators are running, the path to grid state node 712 is taken out of battery state node 706 when the batteries are charged 60% or less and otherwise the path to grid state node 714 is taken. Viewed from a high level perspective, this means that different battery discharge thresholds are used depending on the current generator state.

Similar reasoning applies with respect to the thresholds for nodes 708, 710, 712, and 714. For example, the threshold for node 708 could be 20, node 710 could be 40, node 712 could be 60, and node 714 could be 80. This means that different grid condition thresholds are used depending both on the current generator state and the current battery state.

Note also that decision tree 700 is but one example of a decision tree that can be used consistent with the disclosed implementations. Other decision trees might layer the nodes in a different order, e.g., using grid condition or battery state for the root node, etc. In addition, the decision tree can be continually optimized over time and may grow new paths, change thresholds, delete old paths, etc. One specific example is when new equipment is added or removed from the server installation, the decision tree can be modified accordingly.

In addition, some decision trees may take into account criteria beyond the generator, battery, and grid states shown (e.g., such as current or projected server workloads). Furthermore, some decision trees may have more refined representations of generator state, battery state, and/or grid state. For example, generator state may be represented as a number of minutes to warm up before the generators are fully operational. As another example, generator state can take into account fossil fuel costs used to run the generators. Likewise, battery state can take into account age and projected lifetime of individual batteries, and also the current charge state can be broken up into more refined “buckets” (e.g., 0-25%, 26-50%, 51-75%, and 76-100%). As another example, the grid state can be broken up using multiple thresholds instead of a binary over/undersupplied representation as shown.

### Second Example Algorithm

For the sake of simplicity, the decision tree discussed above was illustrated with a fairly simple set of states for the generators, batteries, and grid—each was illustrated as having only two states (e.g., on/off for the generators, single threshold for the batteries, and single threshold for the grid). However, as also noted, further implementations may use more refined representations of the states of these conditions. For example, some implementations may quantify grid conditions and/or battery discharge levels on a percentage basis, quantile basis, or other more refined schemes.

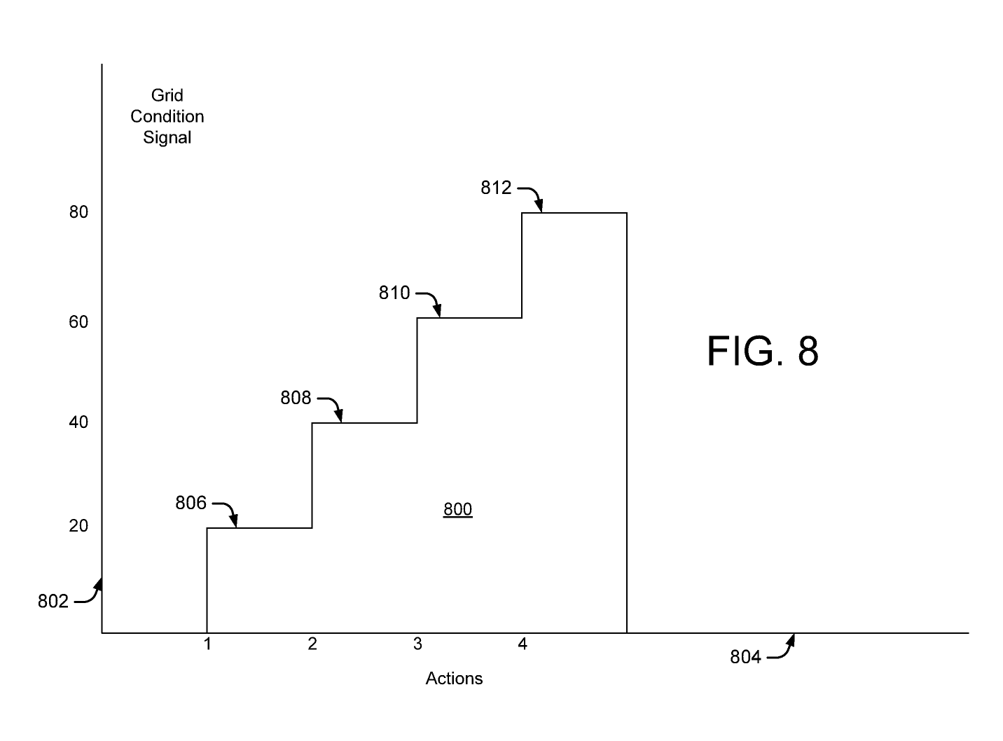

FIG. 8 illustrates an example step function 800, which illustrates how the actions taken can vary as grid conditions grow more severe, e.g., as demand grows relative to supply. Y axis 802 represents a grid condition signal that is quantified using any suitable metric, where a relatively higher number represents relatively more strain on the grid (e.g., higher energy costs). For example, 80 may represent a situation where demand greatly exceeds supply on the grid, whereas 0 may represent a situation where supply greatly exceeds demand.

X axis 804 represents actions that can be taken as different grid conditions occur. Generally speaking, more costly actions can be taken as the strain on the grid grows more severe. For example, thresholds 806, 808, 810, and 812 may be used to trigger individual actions 1, 2, 3, and 4. One way of applying step function 800 is describe below.

By default, when the grid condition signal is below 20, both low and high priority services are allowed to run, the generators are turned off, and the batteries are charged. Once the grid condition signal reaches a value of 20, shown as threshold 806, action 1 is taken. In this example, action 1 represents curtailing a low priority service within the server installation. Once the grid condition signal reaches a value of 40, shown as threshold 808, action 2 is taken. Here, action 2 is turning on generators within the server installation. Once the grid condition signal reaches a value of 60, shown as threshold 810, action 3 is taken. Here, action 3 is discharging local batteries to either provide local power for the servers and/or provide net power to the grid. Once the grid condition signal reaches a value of 80, shown as threshold 810, action 4 is taken. Here, action 4 is curtailing a high priority service on the servers (e.g., turning off servers running the high priority service, placing the servers running the high priority service into a low power consumption state, etc.).

Note that in this example the actions taken are cumulative—in other words, the low priority services remain off for grid condition signal values above 20 as actions 2, 3, and 4 are taken. Likewise, the generators remain on and the low priority services remain off for grid condition signal values above 40. Similarly, the batteries continue to be discharged, the low priority services remain off, and the generators remain on for grid condition signal values above 60. Finally, high priority services are curtailed, the batteries continue to be discharged, the low priority services remain off, and the generators remain on for grid condition signal values above 80.

Note that, like decision tree 700, step function 800 is merely an example and any number of possible implementations are plausible. For example, there may be many more actions than those shown in FIG. 8. In other implementations, multiple actions may be performed at a specific threshold. In addition, the extent to which each action is taken can vary with the values of the grid condition signal.

For example, when the grid condition signal is between 0 and 20, some implementations may run both high and low priority services with a maximum number of virtual machines, leave all servers in a high power consumption state, leave generators off, and maintain batteries at no less than 80% charged. When the grid condition signal reaches 20, the number of virtual machines for the low priority services may be cut in half and servers running the low priority service taken offline or alternatively put into a low power consumption state, while turning the generators on at 50% output and allowing the batteries to discharge to no less than 60% charged. When the grid condition signal reaches 40, the low priority services may be turned off completely along with servers running the low priority services, the generators may be configured to 75% output and the batteries may be allowed to discharge to as low as 40% charged. When the grid condition signal reaches 60, the number of virtual machines for the high priority service can be cut in half and servers running the high priority service taken offline or alternatively put into a low power consumption state, the generators may be configured to 100% output and the batteries may be allowed to discharge to 10%. When the grid condition signal reaches 80, the high priority services may be turned off completely along with servers running the high priority services, the generators may be able to run in short-term overload conditions for up to a rated number of hours per year, and the batteries may be allowed to completely discharge.

Note that the aforementioned decision tree and step function algorithms are merely examples, and any number of mathematical, machine learning, and/or probabilistic techniques can be used to determine which specific actions to perform. For example, some implementations may use an optimization framework, e.g., by optimizing an objective function having terms representing the generator state, energy storage state, grid condition, server workloads, etc. Other implementations may train a neural network, support vector machine, genetic algorithm, etc., to decide which actions to perform.

### Predictive Aspects

The aforementioned implementations can be performed using the current server workloads, current grid conditions, current energy storage state, current generator state, and current server workloads. However, some implementations may also use predictive techniques to estimate future conditions of these values. Thus, the analysis performed at block 608 of method 600 can be performed in view of current and/or future conditions of the grid and/or server workloads.

Consider how server workloads might vary over time. Although day to day fluctuations may exist in server workload, there may be certain patterns to server workload that can influence how the aforementioned algorithms are constructed. For example, daytime and late night server load may be relatively low for user-facing applications such as search engines, video streaming, etc., and relatively higher from 7-10 PM when people tend to be home and using these applications. Suppose that at peak charging rate a given battery can be charged from 50% to 100% in four hours. Thus, as long as a battery at 50% begins charging by 3 PM on a given day, it can be fully charged by the time peak workloads arrive.

Whether to actually begin charging the battery at 3 PM can be determined using algorithms such as those discussed above. More generally, algorithms can take predicted future workloads into account by taking different actions based on the predicted workload. Further implementations may predict longer or shorter term fluctuations in workload, e.g., a shopping service may tend to experience higher workloads in the holiday season, a news service may experience a short-term surge when a major disaster happens, etc. Some implementations may begin charging batteries and/or turning on generators in anticipation of higher future workloads, turn off generators or stop charging batteries in anticipation of lower future workloads, etc. These decisions can also be informed by other considerations such as current or predicted energy storage state, current or predicted generator state, current or predicted grid conditions, etc.

Next, consider predicted energy supply and demand. Energy can be supplied by the grid operator at different rates depending on availability (e.g., how much energy is available from renewable sources) as well as usage (e.g., how much energy is being drawn by energy consumers). For example, cloud conditions can reduce the output of solar generators, low water conditions can reduce the output of hydroelectric generators, etc. Likewise, the aforementioned daily usage patterns for user-facing services may also be present in terms of energy consumption. Thus, some implementations may charge batteries to 100% on a given day that is sunny when it is predicted that the following few days are likely to have substantial cloud cover. Conversely, if there has been substantial cloud cover for a few days and the next day is predicted to be sunny, some implementations may defer charging batteries until the next day because of the expected weather conditions. As another example, it may be useful to begin warming up fossil fuel generators at a specific time in the evening on cloudy days because the batteries have not been charged fully, whereas on sunny days the batteries may have been charged fully during the day so the fossil fuel generators can remain off unless unexpectedly high demand for power and/or services is encountered. More generally, weather, demand for power, and/or other factors that influence grid conditions can be used to predict future grid conditions and the algorithms set forth herein can take these predicted grid conditions into account in determining which actions to perform.

### Generator Considerations

Generators can be useful for several reason to the grid operator. In some cases, generators (particularly fossil fuel) can provide net usable power to the grid during periods of a power deficit. In this case, the grid state can indicate the relationship between supply and demand on the grid, such as the current rate the utility is charging for power or some other representative quantity. Alternatively, the grid operator may explicitly request that the server installation supply net power to the grid.

In addition, generators can provide reactive power to the grid in a manner that helps to provide power factor compensation to help the grid stay within specified power factor parameters. In this case, the server installation may sense the power factor on the grid lines and independently provide power factor compensation. Alternatively, the grid operator may provide an explicit request for power factor compensation by the server installation.

Whether the power management system 310 causes the generators to start up and/or provided reactive power can be a function of various criteria as mentioned above. For example, if the servers are running a critical, uninterruptable process and the batteries are not sufficiently charged to ensure the critical process can complete, the power management system may typically use the generators to charge the batteries instead of to provide power to the grid. Alternatively, if current and short-term predicted server workloads are low and the grid condition signal indicates a seriously undersupplied grid, the power management system can use the generators instead to provide power to the grid.

### Battery Considerations

Generally, battery power is available very quickly and can be provided to the grid to compensate for short-term deficits in power supply on the grid. Indeed, in some cases the request may be honored within a matter of milliseconds. Likewise, the batteries can quickly be flipped to a charging state to help absorb an oversupply condition on the grid. In some cases, the grid state mentioned at block 606 can include an explicit signal from a grid operator requesting that the server installation either provide power to the grid or draw power from the grid, which can be implemented by charging or discharging the batteries. In some cases, the power management system may decide to honor the request and in other cases may decide to decline the request.

For example, if the grid operator requests an immediate short-term request to help with an undersupply condition on the grid, the algorithm may evaluate whether to comply with the request. If the generators are currently not running, e.g., they need 10 minutes to warm up, and the batteries are only charged 30%, this may imply that the server installation will have to curtail high-priority services in order to honor the request. Depending on the specific algorithm, this may not be beneficial to the server installation operator and they may decline the request. Conversely, if the generators are on and/or the batteries are sufficiently charged so that there is very little risk of needing to curtail the high-priority services, the request may be honored by discharging the batteries. This may depend also on how severe of an undersupply condition exists on the grid, as it may be worthwhile to curtail high priority services when the grid is greatly undersupplied and thus possibly at risk of failure (e.g., an outage).

Some implementations may also consider battery aging. Batteries may start out at being able to retain 100% of their rated energy. However, aging may tend to reduce the amount of energy that can be stored in a given battery. In addition, the number of discharge cycles and the depth of discharge can also influence the remaining capacity of a given battery. Thus, some implementations may model battery life by estimating remaining battery capacity as a function of the age of the battery, number and depth of discharge, etc. When initially deployed, the batteries may be able to handle any expected server workloads when charged to 80%, even in the absence of grid power. Three years later, the batteries may need to be charged to 100% to handle similar workloads.

In addition, the amount of time it takes to charge a battery may be a function of the current depth of discharge. It may take an hour to charge a battery from 20% to 70% and another hour to charge the battery from 70% to 80%. This can impact when the algorithm begins charging batteries because if 80% of battery capacity is expected to be needed then it may be appropriate to begin charging the batteries two hours before peak workloads, even when the grid is relatively undersupplied.

Thus, in some implementations, the power management system 310 can consider both battery aging and battery charge times in deciding which actions to take. For example, with new batteries, the power management system may leave low priority services running when the grid exhibits a short-term fluctuation (e.g., grid condition signal spikes upward) because the new batteries have enough capacity to keep the servers running for the duration of the spike. After three years of discharge cycles, the power management system may turn off the low priority services under similar conditions.

As another example, deep discharge cycles can damage the batteries (e.g., shorten their lifetime) so some implementations may consider this as well. If the grid operator requests that the server installation provide net power to the grid, the power management system 310 might do so if it can accomplish this without discharging the batteries below 20%. However, if the batteries will need to be discharged below 20% to handle the request, the power management system may decide not to discharge the batteries. This decision can also be influenced by current/future workloads, grid conditions, and/or generator state.

### Server Considerations

As discussed to some extent above, software services can be turned on or off at various times. One way to do this is by placing a given server in a low-power state, e.g., a sleep state, and moving jobs from that server over to another server and/or delaying those jobs until the server reawakens. In either case, the server is drawing less power so the net impact on the grid is the same. Alternatively, when the grid is oversupplied, individual servers can be transitioned to a high power state.

One class of server workloads is deferrable workloads. For example, a search engine may have a user-facing component that is relatively time-sensitive and an indexing component that is not as time-sensitive. In some implementations, indexing operations can be deferred under specific grid/battery/generator conditions while the user-facing component continues operating without being affected by these conditions.

### Control Granularity

The aforementioned implementations discuss controlling the generators, energy storage devices, and services (e.g., software) within a given server installation as a whole. In some cases, it may be useful to control individual generators, individual batteries, and/or individual servers differently depending on the specific conditions that are encountered.

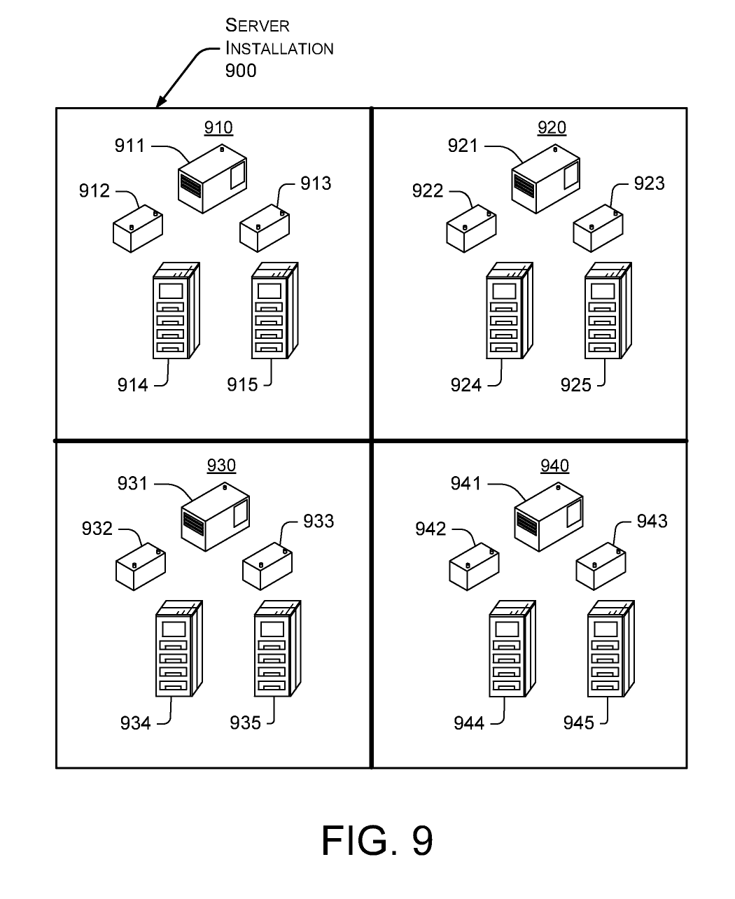

FIG. 9 illustrates an example server installation 900, which can be similar to other server installations discussed herein. Server installation 900 is shown with four rooms, 910, 920, 930, and 940. Room 910 is shown with a generator 911, batteries 912 and 913, and server racks 914 and 915. Likewise, room 920 is shown with a generator 921, batteries 922 and 923, and server racks 924 and 925, room 930 is shown with a generator 931, batteries 932 and 933, and server racks 934 and 935, and room 940 is shown with a generator 941, batteries 942 and 943, and server racks 944 and 945.

Note that the rooms shown in FIG. 9 are intended to convey the electrical relationships between the generators/batteries and the server racks, but not necessarily the true physical locations. For example, generator 911 and batteries 912/913 provide power to server racks 914 and 915 (and perhaps not the other server racks) in the examples set forth herein. However, generator 911 and/or batteries 912 and 913 do not necessarily need to be physically collocated with server racks 914 and 915. This is true with respect to rooms 920, 930, and 940 as well—the purpose of illustrating certain generators and power supplies in a room with certain server racks is to convey that these generators/power supplies are electrically connected to those server racks for the purposes of power distribution.

The energy hardware and servers can be controlled individually in different ways consistent with the above discussion. For example assume that servers 914 and 915 in room 910 run a high-priority service and that servers 924 and 925 in room 920 run a low priority service. In some implementations, the power management system 310 may adopt a more conservative approach for preserving battery power for the high priority service.

For example, instead of the single decision tree shown in FIG. 7, some implementations may use different decision trees for the servers running the high priority service than for the servers running the low priority service. The battery threshold for turning on the generators for the high priority service may be different (e.g., when the batteries discharge to 60%) than for turning on the generators for the low priority service (e.g., when the batteries discharge to 30%) for a given grid signal (e.g., a value of 40). As the grid signal increases (e.g., to a value of 60), the battery threshold for both the high priority and low priority services may increase, e.g., to 70% and 40%, respectively. This means that as the grid signal increases the generators will be turned on relatively sooner as the batteries become discharged to 70% for the high priority services versus 40% for the low priority services.

Further implementations may have multiple services sharing individual generators and/or batteries. For example, room 930 may have a high priority service on server 934 and a low priority service on server 935. Both of these servers may share generator 931, but have respective dedicated batteries 932 and 933. Thus, different decision trees can be used for servers 934 and 935, where both decision trees consider the state of generator 931. However, the decision tree for server 934 might consider the state of battery 932 and not battery 933, and likewise the decision tree for server 935 might consider the state of battery 933 and not battery 934. Again, these two decision trees may have different thresholds for the grid signal, battery threshold, or any other criteria considered by the decision tree.

Still further implementations may have multiple services on a single server. For example, servers 944 and 945 may run both a high priority service and a low priority service, may have dedicated batteries 942 and 943, and share a generator 941. In this case, both servers might use similar decision trees (e.g., equivalent thresholds) and both decision trees may consider the state of generator 941 while considering only their respective dedicated batteries. This may allow the power management system to flexibly control both servers in different ways in response to different battery conditions. For example, the servers might throttle their low priority services under certain grid/generator conditions when the respective battery levels fall below 50%. Thus, there may be times when battery 932 is above 50% and the low priority service is not throttled on server 934 but battery 933 is below 50% and the low priority service is throttled on server 935, and vice versa.

Note that using different control logic for different servers, batteries, and generators can be implemented irrespective of the specific algorithm. For example, different step functions such as step function 800 shown in FIG. 8 can be used for different servers, generators, and/or batteries depending on the specific services that are dependent on those servers, generators, and/or batteries. For example, batteries might be charged and/or generators turned on for relatively lower values of the grid signal for a server running a high priority service, and the grid condition signal may have to reach a higher value to perform these actions for batteries/generators powering a server running a low priority service.

Also, note that the disclosed implementations can be performed at varying levels of granularity, depending to some extent on the amount of control available for various energy hardware devices and computing resources. Some implementations may control servers on a rack-by-rack basis in conjunction with the particular generators and/or batteries that power the servers in that rack. Other implementations may control individual computational resources such storage devices, memories, CPU cores, etc. As long as the power management system 310 can identify which specific pieces of energy hardware are responsible for providing power to a given computational resource, the power management system can control the computational resources and energy hardware in a coordinated manner using the techniques set forth herein.

### Device Implementations

Referring back to FIG. 3, environment 300 as shown includes several components. In this case, for purposes of explanation, the components are characterized as a power management system 310, client device 330, and server installations 170, 223, and 225. In this example, the power management system can be manifest as a server computing device, desktop, tablet, laptop device, etc. Generally, so long as a device has some computational hardware, the device can act as the power management system in accordance with the disclosed implementations. Of course not all device implementations can be illustrated and other device implementations should be apparent to the skilled artisan from the description above and below.

The term “device,” “computer,” “computing device,” “client device,” and or “server device” as used herein can mean any type of device that has some amount of hardware processing capability (e.g., processing resources 312) and/or hardware storage/memory capability (e.g., memory/storage resources 314). Processing capability can be provided by one or more processors (e.g., hardware processing units/cores) that can execute data in the form of computer-readable instructions to provide functionality. Computer-readable instructions and/or data can be stored on storage, such as storage/memory and or a data store.

The storage/memory can be internal or external to the device. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose processor and storage/memory. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor” as used herein can also refer to central processing units (CPUs), graphical processing units (CPUs), controllers, microcontrollers, processor cores, or other types of processing devices suitable for implementation both in conventional computing architectures as well as SOC designs.

In some configurations, the power management system 310 can be installed as hardware, firmware, or software during manufacture of the device or by an intermediary that prepares the device for sale to the end user. In other instances, the end user may install the power management module later, such as by downloading executable code and installing the executable code on the corresponding device.

Also note that devices generally can have input and/or output functionality. For example, computing devices can have various input mechanisms such as keyboards, mice, touchpads, voice recognition, etc. Devices can also have various output mechanisms such as printers, monitors, etc.

Also note that the devices described herein can function in a stand-alone or cooperative manner to implement the described techniques. For example, methods 400, 500, and/or 600 can be performed on a single computing device and/or distributed across multiple computing devices that communicate over network(s) 320. Without limitation, network(s) 320 can include one or more local area networks (LANs), wide area networks (WANs), the Internet, and the like.

As noted above, in some cases the power management system 310 can manipulate the computational resources used for computing jobs at a server installation. The power management system can do so to manipulate the electrical load that the computing jobs place on the server installation and ultimately the grid and/or power generation facility. The term “computational resources” broadly refers to individual computing devices, storage, memory, processors, virtual machines, time slices on hardware or a virtual machine, computing jobs/tasks/processes/threads, etc. Any of these computational resources can be manipulated in a manner that affects the amount of power consumed by a server installation at any given time.

### Further Examples

The various examples discussed herein can include a first method example performed by at least one hardware processing unit. The first method example can include determining a current generator state of a generator in a server installation, determining an energy storage state of an energy storage device in the server installation, and selectively discharging the energy storage device and adaptively adjusting workload performed by a server in the server installation. The selectively discharging and the adaptively adjusting can be based on the current generator state and the energy storage state. In a second method example, the adaptively adjusting of the first method example can include curtailing a low priority service without curtailing a high priority service. In a third method example, the first method example or the second method example can include predicting a future value for a grid condition signal based on historical values of the grid condition signal, and selectively discharging the energy storage device based on the predicted future value for the grid condition signal. In a fourth method example, the first method example through the third method example can include predicting a future value for a grid condition signal based on historical values of the grid condition signal, and adaptively adjusting the workload based on the predicted future value for the grid condition signal. In a fifth method example, the first method example through the fourth method example can include receiving a request from a grid operator to immediately provide power to the grid, and determining whether to turn on the generator and whether to discharge the energy storage device in response to the request from the grid operator.

The various examples discussed herein can also include a first example system that includes a hardware processing unit and a hardware storage device storing instructions which, when executed by the hardware processing unit, cause the hardware processing unit to determine a targeted quantity of electrical power for a server installation to supply to a grid or to draw from the grid, perform an analysis of a generator state and an energy storage state at the server installation, and based on the analysis, cause the server installation to supply the targeted quantity of electrical power to the grid or to draw the targeted quantity of electrical power from the grid by adjusting a server workload at the server installation and adjusting at least one of the generator state or the energy storage state. In a second example system, the generator state of the first example system includes a current running state of a generator of the server installation. In a third example system, the instructions of the second example system cause the hardware processing unit to adjust the current running state of the generator by causing the generator to turn on or off. In a fourth example system, the energy storage state of the first through third example systems includes a discharge state of an energy storage device of the server installation. In a fifth example system, the instructions of the first through fourth example system cause the hardware processing unit to adjust the discharge state of the energy storage device by causing the energy storage device to begin charging or to stop charging. In a sixth example system, the instructions of the first through fifth example system cause the hardware processing unit to predict a future server workload of the server installation based on historical server workloads of a service provided by the server installation and, based on the predicted future server workload, selectively turn on or off a generator of the server installation. In a seventh example system, the instructions of the first through sixth example system cause the hardware processing unit to predict a future server workload of the server installation based on historical server workloads of a service provided by the server installation, and, based on the predicted future server workload, selectively charge or discharge an energy storage device of the server installation.

The various examples discussed herein can include an additional first method example performed by a hardware processing unit. The additional first method example can include determining a generator state within a server installation, determining an energy storage state within the server installation, determining a grid state on a grid that provides energy to the server installation, analyzing the generator state, the energy storage state, and the grid state to determine an energy hardware action or a server action to apply at the server installation, and causing the server installation to apply the energy hardware action or the server action. In a second additional method example, the energy storage state of the first additional method example includes a current discharge state of an energy storage device of the server installation. In a third additional method example, the second additional method example includes modeling an impact of discharging the energy storage device on a lifetime of the energy storage device. In a fourth additional method example, the energy hardware action of the second additional method example or the third additional method example includes discharging the energy storage device and the analyzing includes considering the impact of the discharging on the lifetime of the energy storage device. In a fifth additional method example, the generator state of the first through fourth additional method examples includes a current running state of a generator of the server installation. In a sixth additional method example, the analyzing of the first through fifth additional method examples includes selectively determining whether to discharge an energy storage device at the server installation based on the current running state of the generator. In a seventh additional method example, the analyzing of the first through sixth additional method examples includes determining whether to adjust at least one software service based on the current running state of the generator and a discharge state of the energy storage device. In an eighth additional method example, the analyzing of the first through seventh additional method examples includes determining whether to adjust a software service based on the current running state of the generator, a discharge state of the energy storage device, and a grid condition signal that reflects availability of energy from the grid.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
determining a current generator state of a generator in a server installation;
determining an energy storage state of an energy storage device in the server installation; and
based on the current generator state and the energy storage state, selectively discharging the energy storage device and adaptively adjusting workload performed by a server in the server installation.

2. The method of claim 1, wherein the adaptively adjusting comprises curtailing a low priority service without curtailing a high priority service.

3. The method of claim 1, further comprising:
predicting a future value for a grid condition signal based on historical values of the grid condition signal; and
selectively discharging the energy storage device based on the predicted future value for the grid condition signal.

4. The method of claim 1, further comprising:
predicting a future value for a grid condition signal based on historical values of the grid condition signal; and
adaptively adjusting the workload based on the predicted future value for the grid condition signal.

5. The method of claim 1, further comprising:
receiving a request from a grid operator to immediately provide power to the grid; and
determining whether to turn on the generator and whether to discharge the energy storage device in response to the request from the grid operator.

6. A system comprising:
a hardware processing unit; and
a hardware storage device storing instructions which, when executed by the hardware processing unit, cause the hardware processing unit to:
determine a targeted quantity of electrical power for a server installation to supply to a grid or to draw from the grid;
perform an analysis of a generator state and an energy storage state at the server installation; and
based on the analysis, cause the server installation to supply the targeted quantity of electrical power to the grid or to draw the targeted quantity of electrical power from the grid by adjusting a server workload at the server installation and adjusting at least one of the generator state or the energy storage state.

7. The system of claim 6, wherein the generator state comprises a current running state of a generator of the server installation.

8. The system of claim 7, wherein the instructions cause the hardware processing unit to:
adjust the current running state of the generator by causing the generator to turn on or off.

9. The system of claim 6, wherein the energy storage state comprises a discharge state of an energy storage device of the server installation.

10. The system of claim 9, wherein the instructions cause the hardware processing unit to:
adjust the discharge state of the energy storage device by causing the energy storage device to begin charging or to stop charging.

11. The system of claim 6, wherein the instructions cause the hardware processing unit to:
predict a future server workload of the server installation based on historical server workloads of a service provided by the server installation; and
based on the predicted future server workload, selectively turn on or off a generator of the server installation.

12. The system of claim 6, wherein the instructions cause the hardware processing unit to:
predict a future server workload of the server installation based on historical server workloads of a service provided by the server installation; and
based on the predicted future server workload, selectively charge or discharge an energy storage device of the server installation.

13. A method comprising:
determining a generator state within a server installation;
determining an energy storage state within the server installation;
determining a grid state on a grid that provides energy to the server installation;
analyzing the generator state, the energy storage state, and the grid state to determine an energy hardware action or a server action to apply at the server installation; and
causing the server installation to apply the energy hardware action or the server action.

14. The method of claim 13, wherein the energy storage state comprises a current discharge state of an energy storage device of the server installation.

15. The method of claim 14, further comprising:
modeling an impact of discharging the energy storage device on a lifetime of the energy storage device.

16. The method of claim 15, wherein the energy hardware action comprises discharging the energy storage device and the analyzing includes considering the impact of the discharging on the lifetime of the energy storage device.

17. The method of claim 13, wherein the generator state comprises a current running state of a generator of the server installation.

18. The method of claim 17, wherein the analyzing comprises selectively determining whether to discharge an energy storage device at the server installation based on the current running state of the generator.

19. The method of claim 18, wherein the analyzing comprises determining whether to adjust at least one software service based on the current running state of the generator and a discharge state of the energy storage device.

20. The method of claim 18, wherein the analyzing comprises determining whether to adjust a software service based on the current running state of the generator, a discharge state of the energy storage device, and a grid condition signal that reflects availability of energy from the grid.
